(19) United States
(12) Patent Application Publication
(10) Pub. No.: US 2025/0081273 A1
(43) Pub. Date: Mar. 6, 2025

(54) INHERITANCE BASED LINK ADDITION TO MULTI-LINK SETUP

(71) Applicant: Cisco Technology, Inc., San Jose, CA (US)

(72) Inventors: Binita GUPTA, San Diego, CA (US); Brian D. HART, Sunnyvale, CA (US)

(21) Appl. No.: 18/819,604

(22) Filed: Aug. 29, 2024

Related U.S. Application Data
(60) Provisional application No. 63/580,211, filed on Sep. 1, 2023.

(51) Int. Cl. H04W 76/20; H04W 76/11; H04W 88/06

(52) U.S. Cl. CPC H04W 76/20; H04W 76/11; H04W 88/06

(57) ABSTRACT

The present disclosure provides techniques for reducing signaling overhead in multi-link reconfiguration. A first MLD generates a first profile for a first link, where the first profile comprises a plurality of parameter sets, each parameter set being allocated an element identifier and comprising a first value set relevant to an operation of the first link. The first MLD generates a second profile for a second link, where one or more parameter sets that have a same value set as in the first profile are omitted, and, for each parameter set that has a different value set from the first profile, the element identifier and a second value set are incorporated into the second profile. The first MLD generates a link reconfiguration frame including the first and second profiles, and sends the frame to a second MLD.

### CROSS-REFERENCE TO RELATED APPLICATIONS

This application claims benefit of co-pending U.S. provisional patent application Ser. No. 63/580,211 filed Sep. 1, 2023. The aforementioned related patent application is herein incorporated by reference in its entirety.

### TECHNICAL FIELD

Embodiments presented in this disclosure generally relate to multi-link reconfiguration. More specifically, embodiments disclosed herein relate to reducing signaling overhead for multi-link setup by managing parameter inheritance across multiple per-STA profile subelements.

### BACKGROUND

The IEEE 802.11 be amendment defines procedures for seamlessly adding links to the multi-link (ML) setup of a non-access point (AP) multi-link device (non-AP MLD) (also be referred to as station multi-link device (STA MLD)). This allows a non-AP MLD to dynamically add one or more links to its ML setup without the need for reassociation. This operation utilizes Link Reconfiguration Request/Response frames. In the Link Reconfiguration Request frame, the STA MLD requesting the addition of a new link specifies the new link's STA profile in the Per-STA Profile subelement within the Reconfiguration Multi-link (ML) element. In the Link Reconfiguration Response frame, the AP MLD indicates the profiles of APs for which the AP MLD accepts the link addition in the Per-STA Profile subelements within the Basic ML element.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 depicts an example environment where STA MLD adds multiple links within its current configuration, according to some embodiments of the present disclosure.

FIG. 2 depicts an example Reconfiguration ML element, according to some embodiments of the present disclosure.

FIG. 3 depicts an example Reconfiguration ML element comprising two Per-STA Profile subelements with complete parameter inheritance, according to some embodiments of the present disclosure.

FIG. 4 depicts an example Reconfiguration ML element comprising two Per-STA Profile subelements with non-complete parameter inheritance, according to some embodiments of the present disclosure.

FIG. 5 depicts an example Reconfiguration ML element comprising two Per-STA Profile subelements with a global non-inheritance field, according to some embodiments of the present disclosure.

FIG. 6 depicts an example Reconfiguration ML element comprising two Per-STA Profile subelements with a profile-specific non-inheritance field, according to some embodiments of the present disclosure.

FIG. 7 depicts an example method of generating Link Reconfiguration Request frames comprising multiple Per-STA Profile subelements with inheritance rules applied, according to some embodiments of the present disclosure.

FIG. 8 is a flow diagram depicting an example method for managing parameter inheritance across multiple Per-STA Profile subelements, according to some embodiments of the present disclosure.

FIG. 9 depicts an example network device configured to perform various aspects of the present disclosure, according to some aspects of the present disclosure.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure provides a method, including generating, by a first multi-link device (MLD), a first profile for a first link, where the first profile comprises a plurality of parameter sets, each respective parameter set being allocated a respective element identifier and comprising a respective first value set relevant to an operation of the first link, generating, by the first MLD, a second profile for a second link, generating, by the first MLD, a link reconfiguration frame comprising the first and second profiles, and transmitting, by the first MLD, the link reconfiguration frame to a second MLD. The generation of the second profile comprises omitting, in the second profile, one or more of the parameter sets within the plurality of parameter sets that have a same value set as in the first profile, and, for each parameter set within the plurality of parameter sets that has a different value set from the first profile, incorporating the respective element identifier and a respective second value set relevant to an operation of the second link into the second profile.

Other embodiments in this disclosure provide one or more non-transitory computer-readable media containing, in any combination, computer program code that, when executed by operation of a computer system, performs operations in accordance with one or more of the above methods, as well as a system of a network device comprising one or more computer processors, and one or more memories collectively containing one or more programs, which, when executed by the one or more computer processors, perform operations in accordance with one or more of the above methods.

### EXAMPLE EMBODIMENTS

As defined in IEEE 802.11 be, a non-AP MLD may seamlessly add links to its ML setup without the need for reassociation by sending a Link Reconfiguration Request frame to the AP. The Link Reconfiguration Request frame includes a Reconfiguration ML element, which further includes a Per-STA Profile subelement that contains all necessary parameters relevant to the operation and establishment of the new link for the non-AP MLD. When receiving the request, the AP evaluates these parameters and determines whether the new link can be added based on network policies and available resources. If the AP approves the request and decides to establish the link, it sends a Link Reconfiguration Response frame to the non-AP MLD. This response frame includes the necessary configuration details within the Basic ML element, such as the new link's parameters, channel access settings, and any security credentials required to set up the link.

In some embodiments, a non-AP MLD may request to add multiple links to its ML setup in a single Link Reconfiguration Request frame. This can be achieved by the non-AP MLD sending a Link Reconfiguration Request frame to either an associated AP MLD or a new AP MLD that the non-AP MLD intends to roam to. The Link Reconfiguration Request frame may include multiple Per-STA Profile subelements, each corresponding to a respective link and containing the full profile for the non-AP STA. The AP MLD may process the request, and if approved, the AP MLD may send a Link Reconfiguration Response frame back to the STA MLD. The response frame may also include multiple Per-STA Profile subelements, each containing the full profile for the AP MLD and relevant parameters to establish a respective link.

The IEEE 802.11be amendment does not define inheritance rules for parameters (or elements) across these Per-STA Profile subelements within the Reconfiguration ML element and Basic ML element. As a result, the current approach defined in the IEEE 802.11 be amendment for the add link operation may include parameters common across Per-STA Profile subelements multiple times in the same Link Reconfiguration Request/Response frame. This redundancy makes the frames lengthy and consumes more airtime.

Embodiments of the present disclosure introduce techniques to optimize signaling overhead for ML reconfiguration and, more specifically, to reduce the size of Link Reconfiguration Request/Response frames through the application of inheritance rules across the Per-STA Profile subelements. This method effectively minimizes (or at least reduces) redundancy and reduces airtime consumption.

The Per-STA Profile subelements within Link Reconfiguration Request/Response frames may include various parameters (or elements) concerning the operation of the non-AP STA and AP MLD, as well as parameters relevant to the establishment of the new link between the two devices. These parameters include, but are not limited to, the STA MAC address, the AP MAC address, channel access parameters, security capabilities and configurations, and power management parameters.

In some embodiments, Element Identifiers (IDs) and/or Element ID Extensions may be assigned to one or more parameters (or elements) included within the Per-STA Profile subelement. When multiple links are added between the non-AP STA and AP MLD, leading to multiple Per-STA Profile subelements within a single Link Reconfiguration Request/Response frame, the first Per-STA Profile subelement may contain a complete profile, including all necessary operational and link establishment parameters for the non-AP STA. Subsequent Per-STA Profile subelements may inherit (implicitly or explicitly through a Positive Inheritance element) all values from the first profile, unless they include the Element Identifiers (IDs) and/or Element ID Extensions with new values or if t these Element Identifiers (IDs) and/or Element ID Extensions are listed in a Non-Inheritance element. The disclosed inheritance mechanism significantly reduces the size of the Link Reconfiguration Request/Response frame by avoiding the repetition of identical parameters (or elements) across multiple Per-STA profiles.

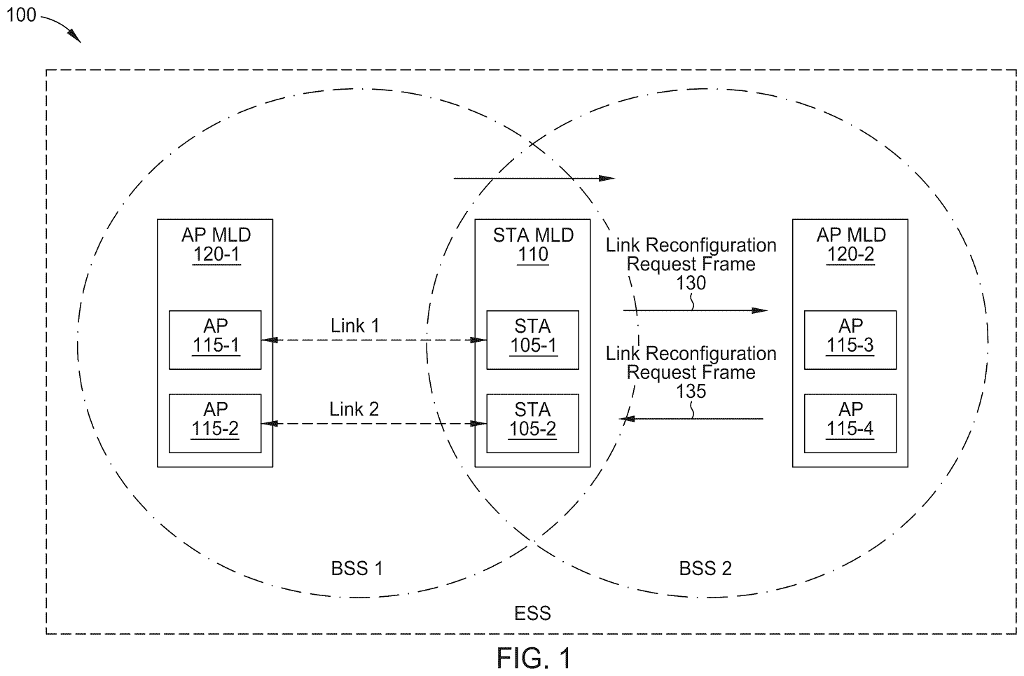

FIG. 1 depicts an example environment 100 where STA MLD 110 adds multiple links within its current configuration, according to some embodiments of the present disclosure.

As depicted, the example environment 100 contains two basic service sets (BSSs), including BSS 1 and BSS 2. The two BSSs are within the same ESS. BSS 1 includes AP MLD 120-1, and BSS 2 includes AP MLD 120-2. Each AP MLD consists of two radios. As illustrated, AP MLD 120-1 includes AP 115-1 and AP 115-2, and AP MLD 120-2 includes AP 115-3 and AP 115-4.

As illustrated, STA MLD 110 comprises two radios, including STA 105-1 and STA 105-2. As used herein, the term “radio” may refer to the capability to connect to a peer device on a link. The two radios 105-1 and 105-2, as depicted within STA MLD 110, may represent either two physical radios or two logical radios enabled by a single physical radio (which is capable of being used on two different links in a time-switched fashion).

As depicted, STA MLD 110 is located in the overlapping area of the two BSSs and is currently connected to AP MLD 120-1 through two links: link 1 and link 2. Link 1 connects AP 115-1 to STA 105-2, and link 2 connects AP 115-2 to STA 105-2. The STA MLD 110 is moving in a direction away from AP MLD 120-1 and closer to AP MLD 120-2. Therefore, the STA MLD 110 is roaming to AP MLD 120-2 and intends to establish two new links: one link between STA 105-1 and AP 115-3, and another link between STA 105-2 and AP 115-4.

In order to set up the new links, STA MLD 110 sends a Link Reconfiguration Request frame 130 to AP MLD 120-2. The request frame 130 may include two Per-STA Profile subelements within its Reconfiguration ML element, each profile corresponding to a respective newly added link. For example, the first Per-STA Profile subelement may include all necessary parameters for establishing the link between STA 105-1 and AP 115-3, and the second Per-STA Profile subelement may include all necessary parameters for establishing the link between STA 105-2 and AP 115-4.

AP MLD 120-2 receives the Link Reconfiguration Request frame 130, and evaluates the request based on current network policies and available network resources. If the AP MLD 120-2 approves the request, it sends a Link Reconfiguration Response frame 135 to the STA MLD 110. The response 135 may also include two Per-STA Profile subelements within the Basic ML element, each comprising (if accepted) configuration details for the respective new links: one for the link between STA 105-1 and AP 115-3, and the other for the link between STA 105-2 and AP 115-4.

In conventional systems, without inheritance rules defined and applied, each Per-STA Profile subelement within the Link Reconfiguration Request/Response frames 130 and 135 includes a complete profile for establishing a respective new link. As a result, identical parameters (or elements) may be repetitively included within each profile, resulting in increased frame length and greater airtime consumption. In the depicted system where inheritance rules are defined and applied across the Per-STA Profile subelements, redundant parameter repetitions may be avoided, therefore reducing signaling overhead and optimizing airtime usage.

The STA MLD 110 comprising two radios (e.g., STA 105-1 and STA 105-2), as depicted in FIG. 1, is provided for conceptual clarity. In some embodiments, the STA MLD 110 may comprise more than two radios and need to add more than two links when roaming from AP MLD 120-1 to AP MLD 120-2. In this configuration, the Link Reconfiguration Request/Response frames may contain multiple (e.g., more than two) Per-STA Profile subelements. If each subelement contains the full profile, it may make the frames unnecessarily lengthy and inefficient, and thus consume excessive airtime. Therefore, to avoid the repetition of identical parameters (or elements) across multiple profiles, inheritance rules relative to the first profile may be implemented in the Link Reconfiguration Request/Response frames 130 and 135. By applying these rules, only unique parameters or changes are included in subsequent Per-STA Profile subelements, which effectively reduces signaling overhead and enhances the overall efficiency of ML reconfiguration.

In some embodiments, STA MLD 110 may remain connected to AP MLD 120-1 but intend to add additional links within the same configuration. STA MLD 110 may send a Link Reconfiguration Request frame 130 to AP MLD 120-1 to establish these additional links. The request may include multiple Per-STA Profile subelements, each corresponding to a new link to STA MLD intends to add. The AP MLD 120-1 may process the request, and if approved, the AP MLD 120-1 may send a Link Reconfiguration Response frame 135 back to the STA MLD 110. The response may also include multiple Per-STA Profile subelements, each providing the necessary details to establish a new link. Inheritance rules may also be applied to these Link Reconfiguration Request/Response frames to reduce redundancy and optimize the reconfiguration process.

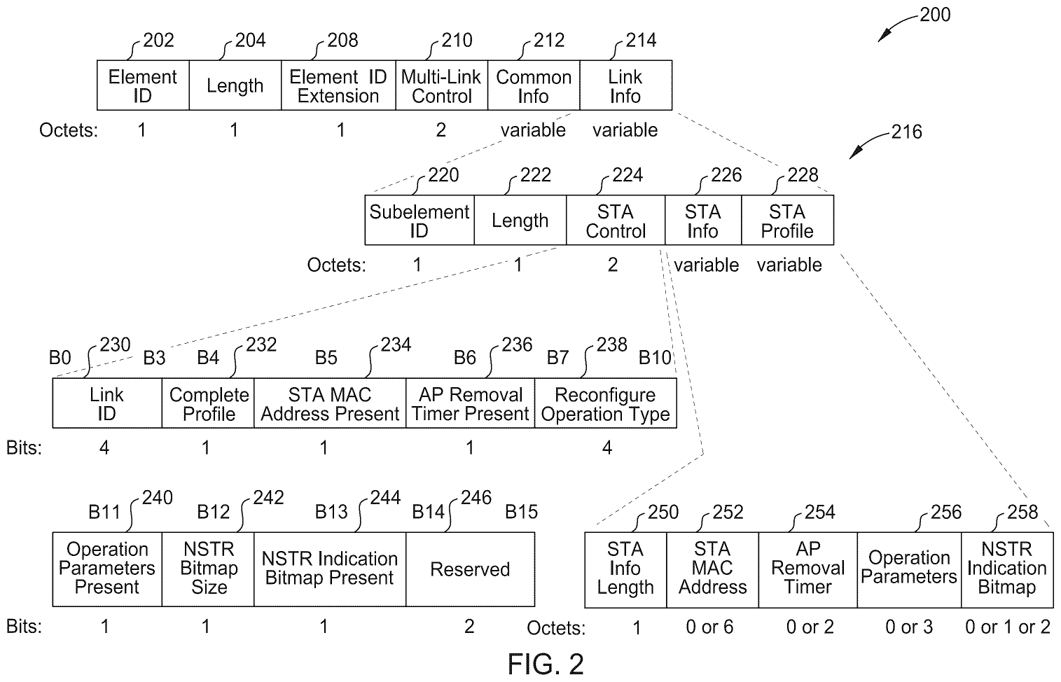

FIG. 2 depicts an example Reconfiguration ML element 200, according to some embodiments of the present disclosure. In some embodiments, the Reconfiguration ML element 200 may be used to initiate ML reconfiguration operations for adding or deleting links to its existing ML setup by the non-AP MLD (e.g., 110 of FIG. 1) and/or to provide recommendations for ML reconfiguration by the AP MLD (e.g., 120-1) to its associated non-AP MLD(s) (e.g., 110 of FIG. 1). In some embodiments, the Reconfiguration ML element 200 may be included within a Link Reconfiguration Request frame (e.g., 130 of FIG. 1).

As illustrated, the Reconfiguration ML element 200 consists of six fields, including the Element ID field 202, Length field 204, Element ID Extension field 208, Multi-Link Control field 210, Common Info field 212, and Link Info field 214. One or more Per-STA Profile subelements 216 are included within the Link Info field 214. Each Per-STA Profile subelement 216 represents a specific link configuration for a non-AP STA (e.g., 110 of FIG. 1).

As illustrated, each Per-STA Profile subelement 216 includes five fields, including Subelement ID field 220, Length field 222, STA Control field 224, STA Info field 226, and STA Profile field 228. STA Control field 224 contains control information specific to the non-AP STA, which include nine subfields: Link ID subfield 230, Complete Profile subfield 232, STA MAC Address Present subfield 234, AP Removal Timer Present subfield 236, Reconfiguration Operation Type subfield 238, Operation Parameters Present subfield 240, NSTR Bitmap Size subfield 242, NSTR Indication Bitmap Present subfield 244, and Reserved subfield 246. The STA Info field 226 provides detailed information about the STA and includes five subfields: STA Info Length subfield 250, STA MAC Address subfield 252, AP Removal Timer subfield 254, Operation Parameters subfield 256, and NSTR Indication Bitmap subfield 258. The STA Profile field 228 contains the profile data necessary for link establishment. Example parameters (or elements) included within the STA Profile field 228 may include, but are not limited to, channel access parameters, security parameters (e.g., Authentication and Key Management (AKM) Suites, Cipher Suites, Group Cipher Suite, Pairwise Cipher Suite, key management protocols, encryption methods, authentication methods), power management parameters (e.g., power save mode, preferred wake time, maximum sleep duration, maximum transmit power, minimum transmit power), device capability parameters (e.g., supported data rates, supported channels, beamforming capabilities, supported Modulation Coding Scheme (MCS) indexes), and operational parameters (e.g., BSS identifier, BSS load, BSS membership information).

In embodiments where the non-AP STA (e.g., 110 of FIG. 1) adds multiple links, multiple Per-STA Profile subelements 216 may be included within the Link Info field 214 of the Reconfiguration ML element 200. Conventionally, each Per-STA Profile subelement 216 corresponds to a specific link, containing all the necessary parameters for establishing that link.

Parameters (or elements) within these Per-STA Profile subelements 216 may share the same values across multiple links. For example, subfields in the STA Control field 224, such as the Reconfiguration Operation Type 238, may be identical for different links if the same type of reconfiguration is being applied across the links. In the STA Info field 226, subfields like Operation Parameters 256, or AP Removal Timer 254 may remain consistent across different links. Additionally, within the STA Profile field 228, channel access parameters like EDCA parameters and MU-EDCA parameters (e.g., Access Category (AC), Arbitration Inter-Frame Space Number (AIFSN), Minimum Contention Window (CWmin), Maximum Contention Window (CWmax), and Transmission Opportunity Limit (TXOP)) may have the same values for different links when the links are intended to support similar traffic types or applications. Security parameters, such as Authentication and Key Management (AKM) Suites, may be consistent across multiple links if the same security protocols are required.

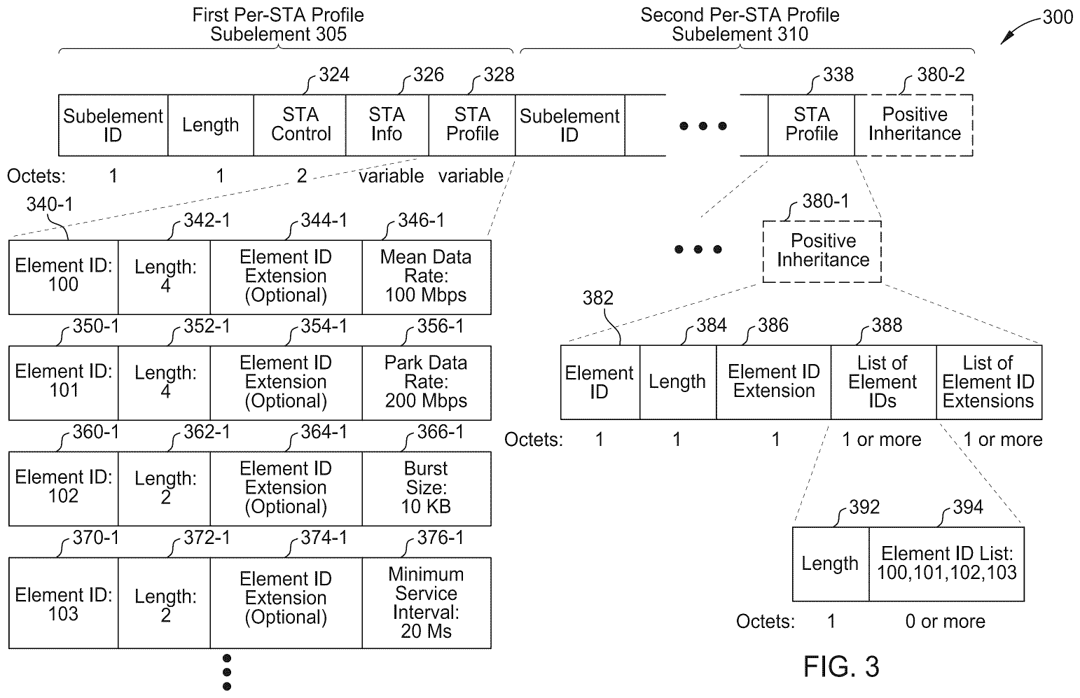

The conventional approaches may include unnecessary repetitions of identical parameters across Per-STA Profile subelements, leading to increased signaling overhead and inefficient use of airtime. To address these issues, inheritance rules may be applied across the Per-STA Profile subelements to eliminate redundancy. More detail related to the application of inheritance rules in generating multiple Per-STA Profile subelements is discussed below with reference to FIGS. 3-6.

FIG. 3 depicts an example Reconfiguration ML element 300 comprising two Per-STA Profile subelements 305 and 310 with complete parameter inheritance, according to some embodiments of the present disclosure.

The two Per-STA Profile subelements 305 and 310 may be included within the Link Info field (e.g., 214 of FIG. 2) of the Reconfiguration ML element 300.

As illustrated, the first Per-STA Profile subelement 305 includes a complete profile, comprising all necessary data explicitly defined to establish a first link. Element IDs and/or Element ID extensions (if applicable) are assigned to each parameter (or element) within the STA Profile field 328 for efficient identification and potential inheritance across multiple profiles. For example, element ID 100 (indicating in the field 340-1) is assigned to the AC, element ID 101 (corresponding to the field 350-1) is assigned to the AIFSN, element 102 (corresponding to the field 360-1) is assigned to the CWmin, and element ID 103 (corresponding to the field 370-1) is assigned to the CWmax.

In the first Per-STA Profile subelement 305, which corresponds to the first link, the STA Profile field 328 includes the following subfields: Element ID subfield 340-1 (indicating Element ID 100), Length subfield 342-1 (indicating a length of 1 octet), Element ID Extension subfield (optional) 344-1, and AC subfield 346-1 (indicating voice (AC_VO)); Element ID subfield 350-1 (indicating Element ID 101), Length field 352-1 (indicating a length of 1 octet), Element ID Extension subfield (optional) 354-1, and AIFSN subfield 356-1 (indicating 2); Element ID subfield 360-1 (indicating Element ID 102), Length field 362-1 (indicating a length of 1 octet), Element ID Extension subfield (optional) 364-1, and CWmin subfield 366-1 (indicating 7); Element ID subfield 370-1 (indicating Element ID 103), Length field 372-1 (indicating a length of 1 octet), Element ID Extension subfield (optional) 374-1, and CWmax subfield 376-1 (indicating 15). These subfields ensure that all necessary parameters for establishing the first link are explicitly defined in the first Per-STA Profile subelement 305.

As illustrated, the second Per-STA Profile subelement 310 is associated with a second link and provides the necessary data to establish that link. Since the second link has the same AC, AIFSN, CWmin, and CWmax as the first link (e.g., potentially due to both links serving the same service type or application), the second Per-STA Profile subelement 310 no longer needs to repeat all these parameters. Instead, the second Per-STA Profile subelement 310 implicitly inherits the data for AC (AC_VO), AIFSN (2), CWmin (7), and CWmax(15) from the first Per-STA Profile subelement 305. Consequently, subfields for element ID, Element ID Extension, length, and/or specific data values are omitted in the second profile, further reducing redundancy and signaling overhead for ML reconfiguration.

In some embodiments, a Positive Inheritance Element 380-1 may be included within the STA Profile 338 for explicit inheritance. More specifically, the Positive Inheritance Element 380-1 may provide explicit information about which parameters (or elements) are inherited by the current profile 310 from the first profile 305. The element ensures clarity where specific parameters needs to be explicitly referenced as inherited. As depicted, the Positive Inheritance Element 380-1 may include five subfields: Element ID subfield 382, Length subfield 384, Element ID Extension subfield (if applicable) 386, List of Element IDs subfield 388, and List of Element ID Extensions subfield 390. The List of Element IDs subfield 388 further includes two additional subfields: Length subfield 392, and Element ID List subfield 394. The Element ID List subfield 394 specifically lists the Element IDs that are inherited by the second Per-STA Profile subelement 310 from the first profile 305. Here, since the first and second links share the same values for the channel access parameters (e.g., AC (AC_VO), AIFSN (2), CWmin (7), and CWmax(15)), the Element ID List subfield 394 explicitly includes Element ID 100, Element ID 101, Element ID 102, and Element ID 103. In some embodiments, the Positive Inheritance Element 380-2 may be added following the STA Profile field 338, rather than being included within the STA Profile field 338 as the last entry.

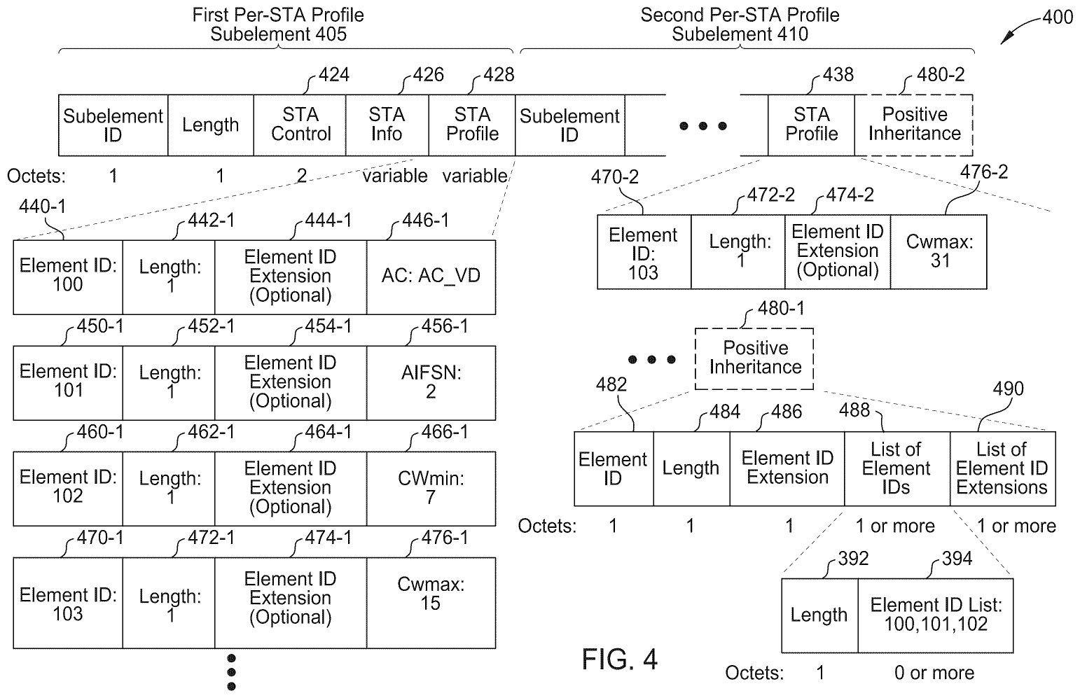

FIG. 4 depicts an example Reconfiguration ML element 400 comprising two Per-STA Profile subelements 405 and 410 with non-complete parameter inheritance, according to some embodiments of the present disclosure.

The two Per-STA Profile subelements 405 and 410 may be included within the Link Info field (e.g., 214 of FIG. 2) of the Reconfiguration ML element 400.

As illustrated, the first Per-STA Profile subelement 405 is identical to the first Per-STA Profile subelement 305 as depicted in FIG. 3. The first Per-STA Profile subelement 405 contains all necessary parameters to establish a first link, including a complete profile with the following subfields: Element ID subfield 440-1 (indicating Element ID 100), Length subfield 442-1 (indicating a length of 1 octet), Element ID Extension subfield (optional) 444-1, and AC subfield 446-1 (indicating voice (AC_VO)); Element ID subfield 450-1 (indicating Element ID 101), Length field 452-1 (indicating a length of 1 octet), Element ID Extension subfield (optional) 454-1, and AIFSN subfield 456-1 (indicating 2); Element ID subfield 460-1 (indicating Element ID 102), Length field 462-1 (indicating a length of 1 octet), Element ID Extension subfield (optional) 464-1, and CWmin subfield 466-1 (indicating 7); Element ID subfield 470-1 (indicating Element ID 103), Length field 472-1 (indicating a length of 1 octet), Element ID Extension subfield (optional) 474-1, and CWmax subfield 476-1 (indicating 15).

In the second Per-STA Profile subelement 410, which corresponds to a second link, most parameters such as AC, AIFSN, and CWmin remain the same as those in the first profile. Therefore, the second Per-STA Profile subelement 410 inherits these parameter values from the first profile. For these parameters, the Element ID, Element ID extension, Length, and specific data field are all omitted in the second profile 410.

However, for the second link, the CWmin differs from that of the first link. To handle higher contention, the CWmax for the second link is set to 31 instead of 15. As a result, the second Per-STA Profile subelement further includes the following subfields: Element ID subfield 470-2 (indicating Element ID 103), Length field 472-2 (indicating a length of 1 octet), Element ID Extension subfield (optional) 474-2, and CWmax subfield 476-2 (indicating 31). The inclusion of the CWmax subfield 476-2 in the second Per-STA Profile subelement 410, with a value of 31, indicates that this new value overrides the value from the first profile (e.g., 15). In other words, parameters (or elements) carried in the STA Profile field 428 of the first Per-STA Profile subelement 405 are inherited and considered part of a subsequent Per-STA Profile subelement 410, unless the STA Profile field 438 of the subsequent Per-STA Profile subelement 410 carries the same Element IDs (e.g., 103) and/or Element ID Extensions with new values (e.g., 31).

In some embodiments, a Positive Inheritance Element 480-1 may be included within the STA Profile 438, providing explicit information about which parameters (or elements) are inherited by the current profile 410 from the first profile 405. As depicted, the Positive Inheritance Element 480-1 may include five subfields: Element ID subfield 482, Length subfield 484, Element ID Extension subfield (if applicable) 486, List of Element IDs subfield 488, and List of Element ID Extensions subfield 490. The List of Element IDs subfield 488 further includes two additional subfields: Length subfield 492, and Element ID List subfield 494. The Element ID List subfield 494 specifically lists the Element IDs that are inherited by the second Per-STA Profile subelement 410 from the first profile 405. Here, since the first and second links share the same values for AC, AIFSN, and CWmin but have different values for CWmax, the Element ID List subfield 494 explicitly includes Element ID 100, Element ID 101, and Element ID 102, indicating that these parameters are inherited. In some embodiments, instead of being included within the STA Profile 438, the Positive Inheritance Element 480-2 may be added following the STA Profile 338 of the second profile 410.

The example Reconfiguration ML element comprising two Per-STA Profile subelements, as depicted in FIGS. 3 and 4, is provided for conceptual clarity. In some embodiments, the Reconfiguration ML element may include any number of Per-STA Profile subelements (including one), depending on the number of links being added to the ML setups. For example, if only one link is added, the Reconfiguration ML element may include a single Per-STA Profile subelement (e.g., 305 of FIG. 3). If multiple links are added, the Reconfiguration ML element may include multiple Per-STA Profile subelements (e.g., 305 and 310 of FIGS. 3, 405 and 410 of FIG. 4), each corresponding to a specific link.

In some embodiments, in addition to the STA Profile field (e.g., 328 of FIG. 3, 428 of FIG. 4), Element IDs and/or Element ID Extensions may also be allocated to parameters (or elements) in the STA Control field (e.g., 324 of FIG. 3, 424 of FIG. 4) and/or STA Info field (e.g., 326 of FIG. 3, 426 of FIG. 4). Examples of such parameters (or elements) may include the Reconfiguration Operation Type (e.g., 238 of FIG. 2), AP Removal Timer (e.g., 254 of FIG. 2), and Operation Parameters (e.g., 256 of FIG. 2). These identifiers allow for efficient management of these parameters (or elements) across multiple profiles. For example, in the second Per-STA Profile subelement (e.g., 310 of FIG. 3, 410 of FIG. 4), if the reconfiguration operation Type and AP removal timer are identical to those in the first Per-STA Profile subelement (e.g., 305 of FIG. 3, 305 of FIG. 4), Element IDs (e.g., Element ID for Reconfiguration Operation Type) may be used within a Positive Inheritance Element (e.g., 380 of FIG. 3, 480 of FIG. 4) to reference these parameters, explicitly indicating that values for these parameters are inherited from the first profile.

FIGS. 3 and 4 illustrate how Element IDs may be allocated to various parameters (or elements) in the STA Profile field (e.g., 328 of FIG. 3, 428 of FIG. 4) for efficient identification and potential inheritance across multiple profiles. While FIGS. 3 and 4 focus on four specific channel access parameters (e.g., AC, AIFSN, CWmin, and CWmax), these examples are provided for conceptual clarity. In some embodiments, the STA Profile field (e.g., 328 of FIG. 3, 428 of FIG. 4) may include a broader range of parameters (or elements) beyond those depicted in FIGS. 3 and 4. For example, the STA Profile field may also include additional EDCA/MU-EDCA parameters. Furthermore, the STA Profile field may contain parameters (or elements) related to security settings (e.g., Authentication and Key Management (AKM) Suites, Cipher Suites, Group Cipher Suite, Pairwise Cipher Suite, key management protocols, encryption methods, authentication method), parameters (or elements) related to power management (e.g., maximum sleep duration, maximum transmit power, minimum transmit power), parameters (or elements) related to device capability (e.g., supported data rates, supported channels, beamforming capabilities, supported MCS indexes), and operational parameters (e.g., BSS identifier, BSS load, BSS membership information).

By allocating Element IDs and/or Element ID Extensions (if applicable) to these various parameters (or elements), the Reconfiguration ML element may effectively manage the information required for link establishment and reconfiguration. In embodiments where multiple links share the same values for certain parameters (or elements), inheritance rules may be applied to reduce redundancy and signaling overhead, as illustrated in FIGS. 3 and 4.

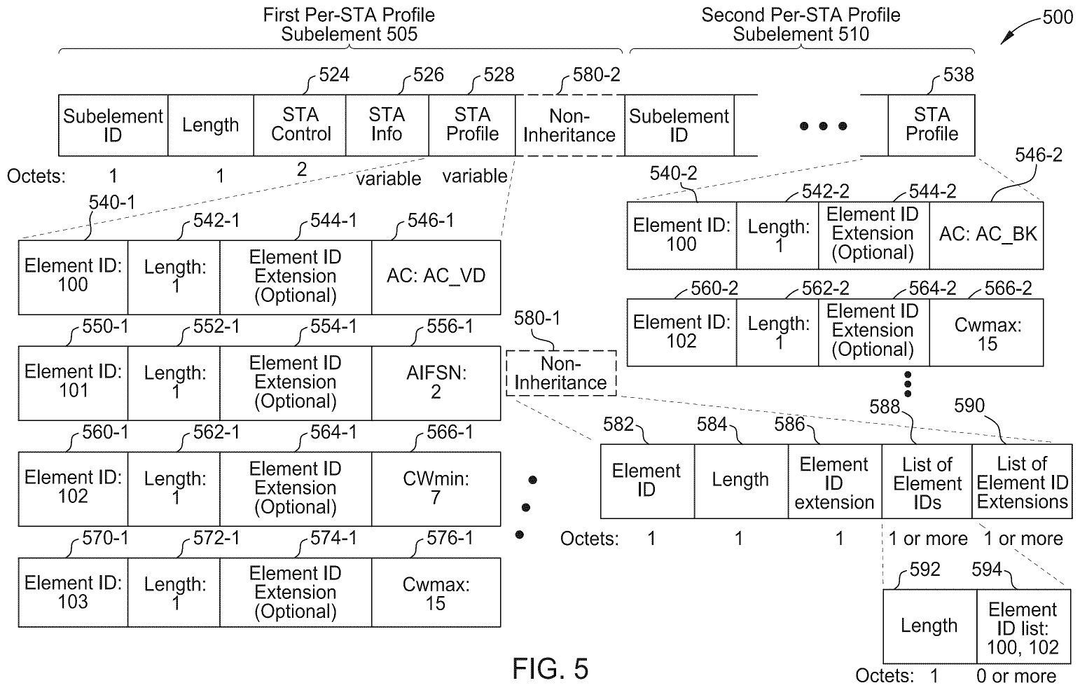

FIG. 5 depicts an example Reconfiguration ML element 500 comprising two Per-STA Profile subelements 505 and 510 with a global non-inheritance field 580, according to some embodiments of the present disclosure.

The two Per-STA Profile subelements 505 and 510 may be included within the Link Info field (e.g., 214 of FIG. 2) of the Reconfiguration ML element 500. The first Per-STA Profile subelement 505 corresponds to a first link, including a complete profile that has all necessary data explicitly defined to establish the first link. The second Per-STA Profile subelement 510 corresponds to a second link and may inherit certain parameters (or elements) from the first profile.

As depicted, the STA Profile field 528 in the first Per-STA Profile subelement 505 is identical to the STA Profile fields 328 and 428 shown in FIGS. 3 and 4, including the following subfields: Element ID subfield 540-1 (indicating Element ID 100), Length subfield 542-1 (indicating a length of 1 octet), Element ID Extension subfield (optional) 544-1, and AC subfield 546-1 (indicating voice (AC_VO)); Element ID subfield 550-1 (indicating Element ID 101), Length field 552-1 (indicating a length of 1 octet), Element ID Extension subfield (optional) 554-1, and AIFSN subfield 556-1 (indicating 2); Element ID subfield 560-1 (indicating Element ID 102), Length field 562-1 (indicating a length of 1 octet), Element ID Extension subfield (optional) 564-1, and CWmin subfield 566-1 (indicating 7); Element ID subfield 570-1 (indicating Element ID 103), Length field 572-1 (indicating a length of 1 octet), Element ID Extension subfield (optional) 574-1, and CWmax subfield 576-1 (indicating 15). However, as depicted in FIG. 5, the first Per-STA Profile subelement 505 further includes a global Non-Inheritance field 580, which is positioned either following but separate from the STA Profile field 528 or within the STA Profile field 528 as its last entry (e.g., 580-1). The global Non-Inheritance field 580 provides information about parameters (or elements) that should not be inherited by any subsequent profiles. Specifically, the global Non-Inheritance field 580 indicates that all subsequent profiles should explicitly include new values for these parameters (or elements), even if those values remain the same or only differ slightly.

As illustrated, the global Non-Inheritance field 580 consists of five subfields, including the Element ID subfield 582, Length subfield 584, Element ID Extension subfield (if applicable) 586, List of Element IDs subfield 588, and List of Element ID Extensions subfield 590. The List of Element IDs subfield 588 further includes two additional subfields: Length subfield 592, and Element ID List subfield 594. The Element ID List subfield 594 specifically lists the Element IDs that cannot be inherited. In other words, parameters (or elements) carried in the STA Profile field 528 of the first Per-STA Profile subelement 505 are inherited and considered part of a subsequent Per-STA Profile subelement 510, unless the first Per-STA Profile subelement 505 includes a global Non-Inheritance field 580 and the Element IDs (e.g., Element ID 100) and/or Element ID extensions for these parameters (or elements) are listed within the global Non-Inheritance field 580.

As depicted, the Element ID List subfield 594 indicates that Element ID 100 (AC) and Element ID 102 (CWmin) cannot be inherited by any subsequent profiles. More specifically, any Per-STA Profile subelements following the first profile should explicitly include new values for AC (e.g., Background (AC_BK) and CWmin (e.g., 15), regardless whether the values remain the same or different.

As illustrated, in the second Per-STA Profile subelement 510, the following subfields are included within its STA Profile field 538: Element ID subfield 540-2 (indicating Element ID 100), Length subfield 542-2 (indicating a length of 1 octet), Element ID Extension subfield 544-2 (optional), AC subfield 546-2 (indicating AC_BK); Element ID subfield 560-2 (indicating Element ID 102), Length subfield 562-2 (indicating a length of 1 octet), Element ID Extension subfield 564-2 (optional), CWmin subfield 566-2 (indicating 15).

Since the global Non-Inheritance field 580 explicitly indicates that values for Element ID 100 (AC) and Element ID 102 (CWmin) cannot be inherited by subsequent profiles, the second Per-STA Profile subelement 510 specifies new values for these two parameters (or elements) (e.g., AC_BK, 15), which override the values (e.g., AC_VO, 7) that are presented in the first profile 505. Additionally, because Element IDs for AIFSN (e.g., Element ID 101) and CWmax (e.g., Element ID 103) are not listed within the global Non-Inheritance field 580, the values for the two parameters are implicitly inherited by the second profile 510. As a result, subfields for AIFSN and CWmax are omitted in the second profile 510.

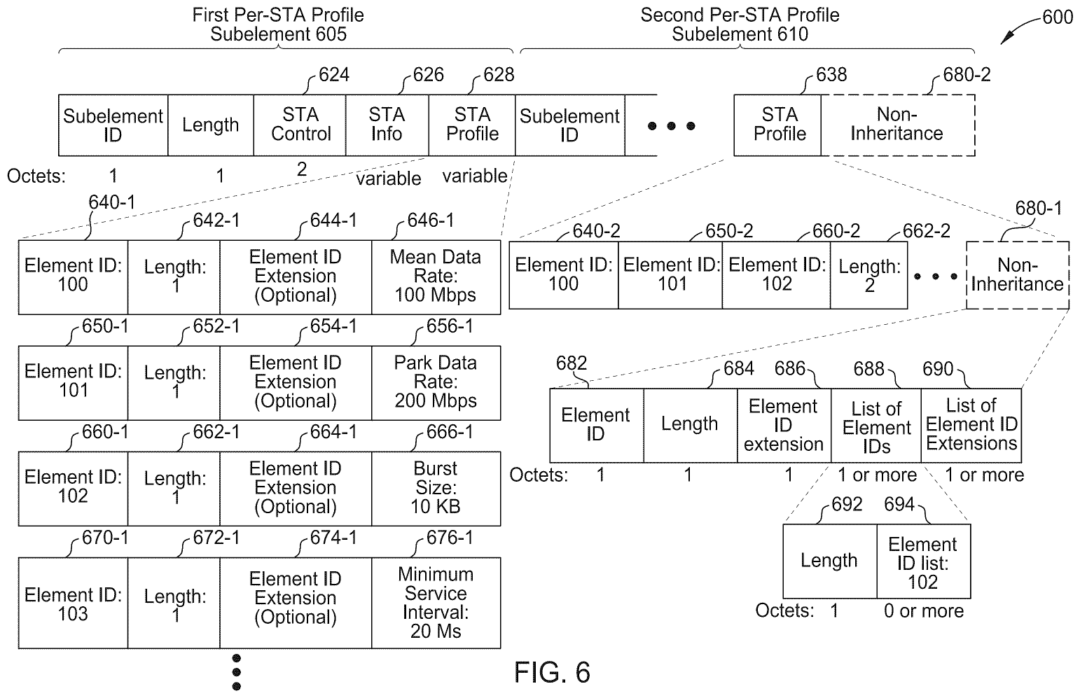

FIG. 6 depicts an example Reconfiguration ML element 600 comprising two Per-STA Profile subelements 605 and 610 with a profile-specific Non-Inheritance field 680, according to some embodiments of the present disclosure.

The two Per-STA Profile subelements 605 and 610 may be included within the Link Info field (e.g., 214 of FIG. 2) of the Reconfiguration ML element 600. The first Per-STA Profile subelement 605 corresponds to a first link, including a complete profile that has all necessary data explicitly defined to establish the first link. The second Per-STA Profile subelement 610 corresponds to a second link and may inherit certain parameters (or elements) from the first profile.

As depicted, the STA Profile field 628 in the first Per-STA Profile subelement 605 is identical to the STA Profile fields 324, 428, and 528 shown in FIGS. 3, 4, and 5, including the following subfields: Element ID subfield 640-1 (indicating Element ID 100), Length subfield 642-1 (indicating a length of 1 octet), Element ID Extension subfield (optional) 644-1, and AC subfield 646-1 (indicating voice (AC_VO)); Element ID subfield 650-1 (indicating Element ID 101), Length field 652-1 (indicating a length of 1 octet), Element ID Extension subfield (optional) 654-1, and AIFSN subfield 656-1 (indicating 2); Element ID subfield 660-1 (indicating Element ID 102), Length field 662-1 (indicating a length of 1 octet), Element ID Extension subfield (optional) 664-1, and CWmin subfield 666-1 (indicating 7); Element ID subfield 670-1 (indicating Element ID 103), Length field 672-1 (indicating a length of 1 octet), Element ID Extension subfield (optional) 674-1, and CWmax subfield 676-1 (indicating 15).

In the second Per-STA Profile subelement 610, FIG. 6 introduces a profile-specific Non-Inheritance field 680. This field provides information about parameters (or elements) in the second profile 610 that differ from the first profile 605. Unlike the global Non-Inheritance field 580 depicted in FIG. 5, which affects all subsequent profiles, the profile-specific Non-Inheritance field 680 only applies to the second profile 610. Only the second profile 610 does not inherit values for these listed parameters (or elements) from the first profile.

As illustrated, the profile-specific Non-Inheritance field 680 is either placed immediately after but separate from the STA Profile 638 (e.g., 680-2), or within the STA Profile field 638, forming its last field if present (e.g., 680-1). The profile-specific Non-Inheritance field 680 consists of five subfields, including the Element ID subfield 682, Length subfield 684, Element ID Extension subfield (if applicable) 686, List of Element IDs subfield 688, and List of Element ID Extensions subfield 690. The List of Element IDs subfield 688 further includes two additional subfields: Length subfield 692, and Element ID List subfield 694. The Element ID List subfield 694 specifically lists the Element IDs that cannot be inherited in the current profile. In other words, parameters (or elements) carried in the STA Profile field 628 of the first Per-STA Profile subelement 605 are inherited and considered part of a subsequent Per-STA Profile subelement 610, unless the subsequent Per-STA Profile subelement 610 includes a profile-specific Non-Inheritance field 680 and the Element IDs (e.g., Element ID 102) and/or Element ID extensions for these parameter (or element) are listed within the profile-specific Non-Inheritance field 680.

As illustrated in FIG. 6, the Element ID List subfield 694 indicates that Element ID 103 (CWmax) cannot be inherited by the second profile 610 from the first profile 605. This represents that the second Per-STA Profile subelement 610 should include a new value for the CWmax, regardless whether the value remains the same or different.

As illustrated, in the second Per-STA Profile subelement 610, the following subfields are included within its STA Profile field 638: Element ID subfield 670-2 (indicating Element ID 103), Length subfield 672-2 (indicating a length of 1 octet), Element ID Extension subfield 674-2 (optional), and CWmax subfield 676-2 (indicating 31).

The profile-specific Non-Inheritance field 680 allows for specific parameters (or elements) to be overridden in the current profile while maintaining the inheritance of other parameters (or elements) from the first profile. In the second Per-STA Profile 610, the new value for the CWmax (e.g., 31) overrides the value (e.g., 15) presented in the first profile, while the values for AC (e.g., AC_VO), AIFSN (e.g., 2), and CWmin (e.g., 7) are implicitly inherited from the first profile, and subfields for these parameters (or elements) are omitted in the second profile 610.

The example Reconfiguration ML element comprising two Per-STA Profile subelements, as depicted in FIGS. 5 and 6, is provided for conceptual clarity. In some embodiments, the Reconfiguration ML element may include any number of Per-STA Profile subelements (including one), depending on how many links are being added to the ML setups.

In some embodiments, in addition to the STA Profile field (e.g., 528 of FIG. 5, 628 of FIG. 6), Element IDs and/or Element ID Extensions may also be allocated to parameters (or elements) in the STA Control field (e.g., 524 of FIG. 5, 624 of FIG. 6) and/or STA Info field (e.g., 526 of FIG. 5, 626 of FIG. 6).

In some embodiments, the global Non-Inheritance field 580 and the profile-specific Non-Inheritance field 680 may be used together in a Reconfiguration ML element. For example, the first Per-STA Profile subelement (e.g., 505 of FIG. 5) may include a global Non-Inheritance field (e.g., 580 of FIG. 5), specifying certain parameters, such as the AC and AIFSN, cannot be inherited by any subsequent profiles. In the same Reconfiguration ML element, the second Per-STA Profile subelement (e.g., 510) may include a profile-specific Non-Inheritance field (e.g., 680 of FIG. 6). This field indicates that a different parameter, such as CWmin, is not inherited by the current profile from the first profile. Consequently, with both the global and profile-specific Non-Inheritance rules applied, the second Per-STA Profile subelement (e.g., 510 of FIG. 5) should include new values for AC, AIFSN, and CWmin.

In some embodiments, the STA Profile field (e.g., 528 and 538 of FIGS. 5, 628 and 638 of FIG. 6) may include a subfield, such as the Complete Profile subfield, to indicate whether the current STA Profile is a complete profile or if it inherits data from a previous profile. In some embodiments, the subfield may use a binary value (e.g., 0 or 1) to indicate the status of the profile. For example, value 1 may be used to indicate that the current STA Profile field includes a complete profile, with all necessary data explicitly defined, and value 0 may be used to indicate that the current STA Profile field is not a complete profile and that it inherits data from a previous profile (e.g., the first Per-STA Profile subelement).

The disclosed inheritance rules across Per-STA Profile subelements relative to the first Per-STA Profile subelement provide an efficient mechanism for managing the configuration of multiple links in a ML setup. According to these rules, a parameter (or element), carried in the first Per-STA Profile subelement, is inherited and considered part of a subsequent Per-STA Profile subelement implicitly (e.g., via silence) or explicitly (e.g., via a Positive Inheritance element) (as depicted in FIGS. 3 and 4). This inheritance remains in effect unless the subsequent Per-STA Profile subelement explicitly includes the same Element ID with new values (as depicted in FIG. 4), or if the Element ID for that parameter is listed in a Non-Inheritance field (either global or profile-specific) (as depicted in FIGS. 5 and 6). In some embodiments, these inheritance rules may be extended and applied to any other management frames beyond Link Reconfiguration Request/Response frames (e.g., 130 or 135 of FIG. 1) that include multiple Per-STA Profile subelements, each intended to carry a complete profile for the corresponding STA.

In some embodiments, there may be situations where even with inheritance rules applied, the payload of a Per-STA Profile subelement may still become too large (e.g., exceeding 255 bytes). In such a configuration, the Per-STA Profile subelements may need to be fragmented to fit within the transmission constraints. The inheritance rules may operate at a higher level than the subelement fragmentation and defragmentation processes. For example, the Per-STA Profile subelements may first be compressed by apply inheritance rules. If the Multi-Link element comprising the compressed Per-STA Profile subelements or a compressed Per-STA Profile subelement itself still exceeds the maximum allowable size (e.g., 255 bytes), the (sub)element may be fragmented into smaller segments. Each fragment may be structured with appropriate headers and metadata to ensure it can be resembled later. The fragment pieces of the (sub)elements may be transmitted in the Link Reconfiguration Request/Response frames over the network. Upon receiving all fragments, the receiving device may reassemble them in the correct order to reconstruct the original ML element and compressed Per-STA Profile subelements. After defragmentation, the inheritance rules may be applied to decompress the Per-STA Profile subelements, such as interpreting the inherited parameters from the first profile and applying these parameters to the subsequent profiles.

In some embodiments, a profile number may be assigned to each Per-STA Profile subelement (e.g., 605 or 610) to uniquely identify it within a link reconfiguration frame. With the profile numbers, more flexible inheritance may be applied across multiple profiles. For example, a third Per-STA Profile subelement may inherit parameters either from the first Per-STA Profile subelement 605 or the second Per-STA Profile subelement 610 by referencing the respective profile numbers. The profile number may act as a reference point that allows the third profile to selectively inherit parameters from one of the earlier profiles. In some embodiments, the reference to the profile number may be included as an additional element within the third Per-STA Profile subelement. The additional element may include one or more profile numbers, indicating from which parameters are being inherited by the third Per-STA Profile subelement.

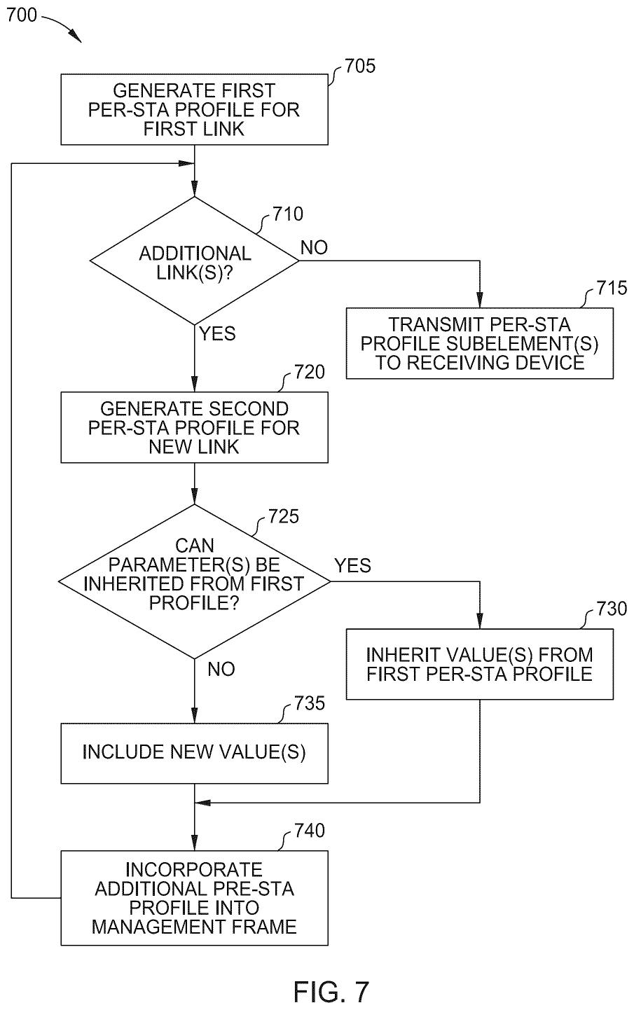

FIG. 7 depicts an example method 700 of generating Link Reconfiguration Request/Response frames comprising multiple Per-STA Profile subelements with inheritance rules applied, according to some embodiments of the present disclosure. In some embodiments, the example method 700 may be performed by a non-AP STA (e.g., 100 of FIG. 1) when attempting to add multiple links to its setup by sending a Link Reconfiguration Request frame. In some embodiments, the example method may be performed by an AP MLD (e.g., AP 120-2 of FIG. 1) when sending back a Link Reconfiguration Response frame, approving the request, and establishing the links.

At block 705, a MLD generates a first Per-STA Profile subelement (e.g., 305 of FIG. 3) for a first link. In some embodiments, the first Per-STA Profile subelement may include a complete profile, with all parameters within the STA Profile field (e.g., 328 of FIG. 3) explicitly defined with a value. Additionally, in some embodiments, each parameter (or element) within the STA Profile field may be allocated a respective Element IDs (e.g., Element ID 100 for mean data rate, as depicted in FIG. 3) and/or Element ID Extensions (if applicable). The allocated Element IDs and/or Element ID Extensions (if applicable) may be used in subsequent profiles to reference these values (carried within the first profile) and facilitate inheritance.

At block 710, the MLD determines whether there is an additional link added. When an additional link is added, an additional Per-STA Profile subelement for this link may be generated and sent along with the first profile. If the MLD determines that no additional link is added, the method 700 proceeds to block 715, where the MLD incorporates the first Per-STA Profile subelement into a management frame and sends it to the receiving device. In embodiments where the MLD is a non-AP MLD (e.g., 110 of FIG. 1), the management frame may refer to a Link Reconfiguration Request frame. In embodiments where the MLD is an AP MLD (e.g., 120-2 of FIG. 1), the management frame may refer to a Link Reconfiguration Response frame.

If the MLD determines that an additional link is added, the method 700 proceeds to block 720, where the MLD generates an additional Per-STA Profile subelement (e.g., 310 of FIG. 3) for the additional link. The additional Per-STA Profile subelement may include all necessary data to establish the additional link. As part of generating the additional Per-STA Profile subelement, at block 725, the MLD determines whether a parameter (or element) can be inherited from the first profile. According to the inheritance rules as discussed above, all parameters (or elements) within the STA Profile field of the first Per-STA Profile subelement can be inherited by the additional Per-STA Profile subelement implicitly (e.g., via silence) or explicitly (e.g., via a Positive Inheritance element), except for parameters (or elements) that require a different value for the additional link or have their Element IDs and/or Element ID Extensions listed in a Non-Inheritance field (either global or profile-specific). If the parameter (element) can be inherited, the method 700 proceeds to block 730, where the Element ID is included in the additional Per-STA Profile subelement to indicate that the value in the first profile is carried to the additional profile. If the parameter cannot be inherited, potentially due to different link requirements or the presence of a Non-Inheritance field, the method 700 proceeds to block 735, where the MLD includes a new value for the parameter in the additional Per-STA Profile subelement. The check may be repeated for each parameter (or element) within the STA Profile field (e.g., 328 of FIG. 3) until all parameters (or elements) have been evaluated and included properly in the second profile.

At block 740, the MLD incorporates the additional Per-STA Profile subelement (e.g., 310 of FIG. 3) into the management frame. The method 700 then returns to block 710, where the MLD continues to determine whether an additional link (e.g., a third link) is added. If an additional link is added, the process of generating another Per-STA Profile subelement continues. If there is no additional link, the method moves to block 715, where the MLD transmits the first and any and all additional Per-STA Profile subelements in the management frame to a receiving device.

In some embodiments, such as when Multi-Link element comprising the compressed Per-STA Profile subelements or a compressed Per-STA Profile subelement itself exceeds a defined size limit (e.g., 255 bytes), the MLD may segment the (sub)element into fragments and send them separately to the receiving device. Each fragment may include a header and metadata, such as sequence numbers or fragment identifiers, to ensure proper reassembly. Upon receiving the fragments, the receiving device may reassemble the fragment pieces into the original (sub)element, and decompress the Per-STA Profile subelements using the inheritance rules.

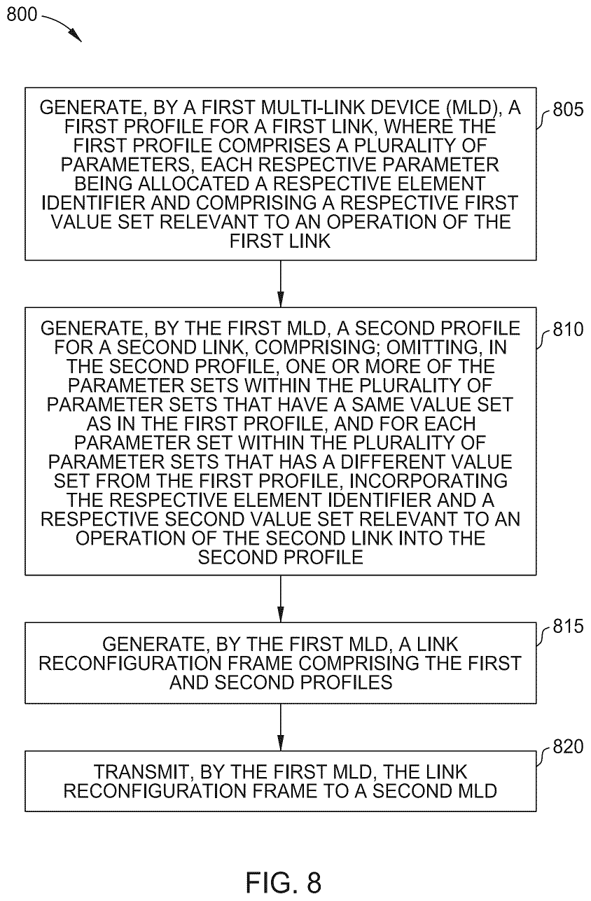

FIG. 8 is a flow diagram depicting an example method 800 for managing parameter inheritance across multiple Per-STA Profile subelements, according to some embodiments of the present disclosure.

At block 805, a multi-link device (MLD) generates a first profile for a first link, where the first profile comprises a plurality of parameter sets, each respective parameter set being allocated a respective element identifier and comprising a respective first value set relevant to an operation of the first link.

At block 810, the MLD generates a second profile for a second link. To generate the second profile, the first MLD omits, in the second profile, one or more of the parameter sets within the plurality of parameter sets that have a same value set as in the first profile, and for each parameter set within the plurality of parameter sets that has a different value set from the first profile, the first MLD incorporates the respective element identifier and a respective second value set relevant to an operation of the second link into the second profile. In some embodiments, the respective second value set may override the respective first value set for the respective element identifier within the second profile.

At block 815, the first MLD generates a link reconfiguration frame comprising the first and second profiles.

At block 820, the first MLD transmits the link reconfiguration frame to a second MLD.

In some embodiments, the first MLD may comprise a station MLD (STA MLD), the second MLD may comprise an access point MLD (AP MLD), and the link reconfiguration frame may comprise a link reconfiguration request frame. In some embodiments, the first MLD may comprise an access point MLD (AP MLD), the second MLD may comprise a station MLD (STA MLD), and the link reconfiguration frame may comprise a link reconfiguration response frame.

In some embodiments, the first MLD may incorporate an additional element within or after the first profile, indicating a list of element identifiers that are not inherited by any subsequent profiles.

In some embodiments, the first MLD may incorporate an additional element within or after the second profile, indicating a list of element identifiers that are not inherited by the second profile from the first profile.

In some embodiments, the second profile may comprise new value sets for parameter sets corresponding to the list of element identifiers, where the new value sets are relevant to the operation of the second link.

In some embodiments, the first profile may comprise a complete profile subfield, the complete profile subfield comprising a number indicating that the first profile comprises a complete set of element identifiers with corresponding parameter sets that are relevant to the operation of the first link.

In some embodiments, the first profile may comprise a complete profile subfield, the complete profile subfield comprising a second number indicating that the second profile inherits the first value set from the first profile.

In some embodiments, the link reconfiguration frame may comprise one or more additional profiles for one or more additional links, and wherein each profile is identified by a profile number.

In some embodiments, a third profile, within the one or more additional profiles, may comprise a reference to one or more profile numbers of at least one of the first profile, the second profile, or the one or more additional profiles, indicating from which parameter sets are inherited.

In some embodiments, the one or more profile numbers may be carried as a new element within the third profile.

In some embodiments, the plurality of parameters in the first profile may comprise at least one of parameters related to channel access, security settings, power management, or network operations.

In some embodiments, the second MLD, upon receiving the link reconfiguration frame, may determine that an element contained in the first profile is part of the second profile if the element is not present in the second profile and that the element is not listed in a non-inheritance element in the second profile.

In some embodiments, the first MLD may determine a size of a multi-link element exceeds a defined threshold, where the multi-link element comprises the first and second profiles and is within the link reconfiguration frame, in response to the determination, divide the multi-link element into a plurality of fragments, where a size of each respective fragment falls below or equal to the defined threshold, and transmit the plurality of fragments via the link reconfiguration frame to the second MLD.

In some embodiments, the first MLD may determine a size of a subelement exceeds a defined threshold, where the subelement comprises the first profile or the second profile and is within the link reconfiguration frame, in response to the determination, divide the subelement into a plurality of fragments, where a size of each respective fragment falls below or equal to the defined threshold, and transmit the plurality of fragments via the link reconfiguration frame to the second MLD.

In some embodiments, the first MLD may comprise a station MLD (STA MLD), the second MLD may comprise an access point MLD (AP MLD), and the link reconfiguration frame may comprise an association request carrying multiple profiles for multiple links.

In some embodiments, the first MLD may comprise an access point MLD (AP MLD), the second MLD may comprise a station MLD (STA MLD), and the link reconfiguration frame may comprise an association response carrying multiple profiles for multiple links.

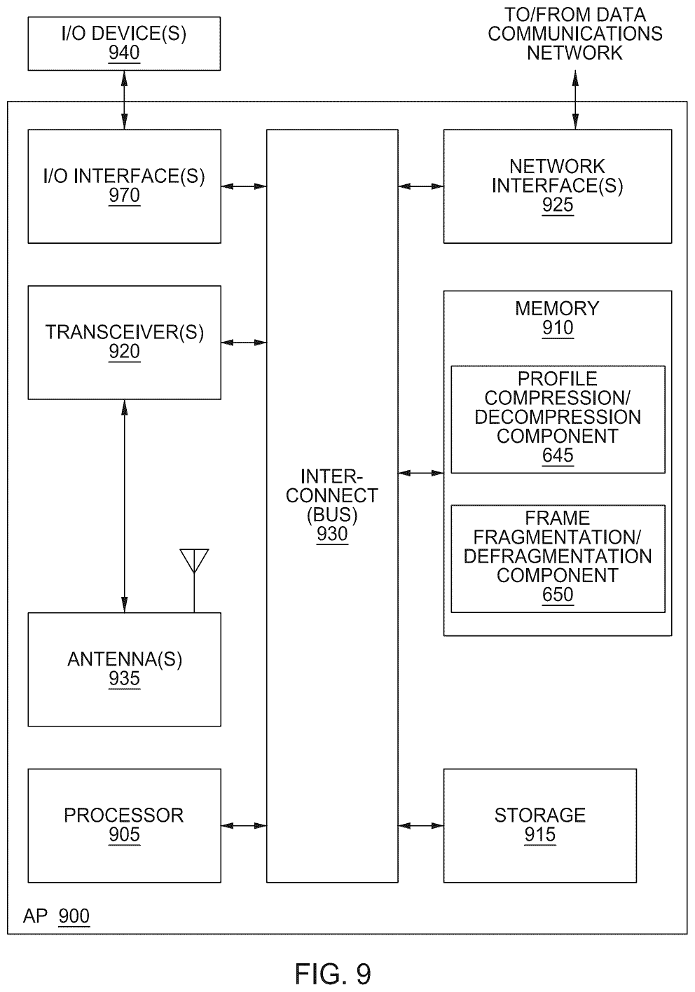

FIG. 9 depicts an example network device 900 configured to perform various aspects of the present disclosure, according to some aspects of the present disclosure. In some embodiments, the example network device 900 may correspond to a non-AP MLD, such as STA 110 as depicted in FIG. 1, or an AP MLD, such as AP MLD 120-1 or 120-2 as depicted in FIG. 1.

As illustrated, the example network device 900 includes a processor 905, memory 910, storage 915, one or more transceivers 920, one or more I/O interfaces 980, and one or more network interfaces 925. In some embodiments, I/O devices 940 are connected via the I/O interface(s) 980. Further, via the network interface 925, the network device 900 can be communicatively coupled with one or more other devices and components (e.g., via a network, which may include the Internet, local network(s), and the like). Each of the components is communicatively coupled by one or more buses 930. In some embodiments, one or more antennas 935 may be coupled to the transceivers 920 for transmitting and receiving wireless signals.

The processor 905 is generally representative of a single central processing unit (CPU) and/or graphic processing unit (GPU), multiple CPUs and/or GPUs, a microcontroller, an application-specific integrated circuit (ASIC), or a programmable logic device (PLD), among others. The processor 905 processes information received through the transceiver 920, I/O interfaces 980, and the network interfaces 925. The processor 905 retrieves and executes programming instructions stored in memory 910, as well as stores and retrieves application data residing in storage 915.

The storage 915 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 915 may store a variety of data for the efficient functioning of the system.

The memory 910 may include random access memory (RAM) and read-only memory (ROM). The memory 910 may store processor-executable software code containing instructions that, when executed by the processor 905, enable the network device 900 to perform various functions described herein for wireless communication. In the illustrated example, the memory 910 includes two software components: the profile compression/decompression component 645 and the frame fragmentation/defragmentation component 650.

In some embodiments, the profile compression/decompression component 645 may be configured to generate and compress the Per-STA Profile subelements before transmission. The profile compression/decompression component 645 may allocate Element IDs and/or Element ID Extensions (if applicable) to parameters (or elements) within the STA Profile field, and apply inheritance rules to reduce redundancy. The profile compression/decompression component 645 may ensure that each profile is either complete or properly inherits values from a previous profile. Additionally, when receiving compressed Per-STA Profile subelements, the profile compression/decompression component 645 may decompress these subelements and reconstruct the full profiles for each link by applying the inheritance rules.

In some embodiments, the frame fragmentation/defragmentation component 650 may handle the segmentation of Multi-Link elements (e.g., 200 of FIG. 2) or Per-STA Profile subelements (e.g., 216 of FIG. 2) when their size exceeds a defined limit (e.g., 255 bytes). The frame fragmentation/defragmentation component 650 may break down a large Multi-Link element or Per-STA Profile subelement into smaller fragments, each with its own header and metadata (e.g., sequence numbers or fragment identifiers) to ensure proper reassembly by the receiving device. Additionally, when receiving the fragments for a (sub)element the frame fragmentation/defragmentation component 650 may reassemble these fragments into the original format for further processing.

Although depicted as a discrete component for conceptual clarity, in some embodiments, the operations of the depicted components (and others not illustrated) may be combined or distributed across any number of components. Further, although depicted as software residing in memory 910, in some aspects, the operations of the depicted components (and others not illustrated) may be implemented using hardware, software, or a combination of hardware and software.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method for managing multiple links in a wireless communication network, comprising:
generating, by a first multi-link device (MLD), a first profile for a first link, wherein the first profile comprises a plurality of parameter sets, each respective parameter set being allocated a respective element identifier and comprising a respective first value set relevant to an operation of the first link;
generating, by the first MLD, a second profile for a second link, comprising:
omitting, in the second profile, one or more of the parameter sets within the plurality of parameter sets that have a same value set as in the first profile and that are relevant to the operation of the second link, and
for each parameter set within the plurality of parameter sets that has a different value set from the first profile, incorporating the respective element identifier and a respective second value set relevant to an operation of the second link into the second profile, and
generating, by the first MLD, a link reconfiguration frame comprising the first and second profiles; and
transmitting, by the first MLD, the link reconfiguration frame to a second MLD.

2. The method of claim 1, wherein the respective second value set overrides the respective first value set for the respective element identifier within the second profile.

3. The method of claim 1, further comprising:
incorporating, by the first MLD, within or after the first profile, a global non-inheritance element indicating a list of element identifiers that are not inherited by any subsequent profiles.

4. The method of claim 1, further comprising:
incorporating, by the first MLD, within or after the second profile, a profile-specific non-inheritance element comprising a list of element identifiers that are not inherited by the second profile from the first profile.

5. The method of claim 3, wherein the second profile comprises new value sets for parameter sets corresponding to the list of element identifiers, wherein the new value sets are relevant to the operation of the second link.

6. The method of claim 1, wherein the first profile comprises a complete profile subfield, the complete profile subfield indicating that the first profile comprises a complete set of element identifiers with corresponding parameter sets that are relevant to the operation of the first link.

7. The method of claim 1, wherein the link reconfiguration frame comprises one or more additional profiles for one or more additional links, and wherein each profile is identified by a profile number.

8. The method of claim 7, wherein a third profile, within the one or more additional profiles, comprises a reference to one or more profile numbers of at least one of the first profile, the second profile, or the one or more additional profiles, indicating from which parameter sets are inherited.

9. The method of claim 1, wherein the plurality of parameter sets comprise at least one of parameters related to channel access, security settings, power management, or network operations.

10. The method of claim 1, wherein the second MLD, upon receiving the link reconfiguration frame, determines that an element contained in the first profile is part of the second profile if the element is not present in the second profile and that the element is not listed in a non-inheritance element in the second profile.

11. The method of claim 1, further comprising:
determining, by the first MLD, a size of a multi-link element exceeds a defined threshold, wherein the multi-link element comprises the first and second profiles and is within the link reconfiguration frame;
in response to the determination, dividing, by the first MLD, the multi-link element into a plurality of fragments, wherein a size of each respective fragment falls below or equal to the defined threshold; and
transmitting, by the first MLD, the plurality of fragments via the link reconfiguration frame to the second MLD.

12. The method of claim 1, further comprising:
determining, by the first MLD, a size of a subelement exceeds a defined threshold, wherein the subelement comprise the first profile or the second profile and is within the link reconfiguration frame;
in response to the determination, dividing, by the first MLD, the subelement into a plurality of fragments, wherein a size of each respective fragment falls below or equal to the defined threshold; and
transmitting, by the first MLD, the plurality of fragments via the link reconfiguration frame to the second MLD.

13. The method of claim 1, wherein the first MLD comprises a station MLD (STA MLD), the second MLD comprises an access point MLD (AP MLD), and the link reconfiguration frame comprises a link reconfiguration request frame.

14. The method of claim 1, wherein the first MLD comprises an access point MLD (AP MLD), the second MLD comprises a station MLD (STA MLD), and the link reconfiguration frame comprises a link reconfiguration response frame.

15. The method of claim 1, wherein the first MLD comprises a station MLD (STA MLD), the second MLD comprises an access point MLD (AP MLD), and the link reconfiguration frame comprises an association request or a reassociation request carrying multiple profiles for multiple links.

16. The method of claim 1, wherein the first MLD comprises an access point MLD (AP MLD), the second MLD comprises a station MLD (STA MLD), and the link reconfiguration frame comprises an association response or a reassociation response carrying multiple profiles for multiple links.

17. A system of a first multi-link device (MLD), comprising:
one or more computer processors; and
one or more memories collectively containing one or more programs, which, when executed by the one or more computer processors, perform operations, the operations comprising:
generating, by the first MLD, a first profile for a first link, wherein the first profile comprises a plurality of parameter sets, each respective parameter set being allocated a respective element identifier and comprising a respective first value set relevant to an operation of the first link;
generating, by the first MLD, a second profile for a second link, comprising:
omitting, in the second profile, one or more of the parameter sets within the plurality of parameter sets that have a same value set as in the first profile, and
for each parameter set within the plurality of parameter sets that has a different value set from the first profile, incorporating the respective element identifier and a respective second value set relevant to an operation of the second link into the second profile;
generating, by the first MLD, a link reconfiguration frame comprising the first and second profiles; and
transmitting, by the first MLD, the link reconfiguration frame to a second MLD.

18. The system of claim 17, wherein the one or more programs, which, when executed by the one or more computer processors, perform the operations further comprising:
incorporating, by the first MLD, within or after the first profile, a global non-inheritance element indicating a list of element identifiers that are not inherited by any subsequent profiles.

19. The system of claim 17, wherein the one or more programs, which, when executed by the one or more computer processors, perform the operations further comprising:
determining, by the first MLD, a size of a multi-link element exceeds a defined threshold, wherein the multi-link element comprises the first and second profiles and is within the link reconfiguration frame;
in response to the determination, dividing, by the first MLD, the multi-link element into a plurality of fragments, wherein a size of each respective fragment falls below or equal to the defined threshold; and
transmitting, by the first MLD, the plurality of fragments via the link reconfiguration frame to the second MLD.

20. One or more non-transitory computer-readable media containing, in any combination, computer program code that, when executed by operation of a computer system, performs operations comprising:
generating, by a first multi-link device (MLD), a first profile for a first link, wherein the first profile comprises a plurality of parameter sets, each respective parameter set being allocated a respective element identifier and comprising a respective first value set relevant to an operation of the first link;
generating, by the first MLD, a second profile for a second link, comprising:
omitting, in the second profile, one or more of the parameter sets within the plurality of parameter sets that have a same value set as in the first profile, and
for each parameter set within the plurality of parameter sets that has a different value set from the first profile, incorporating the respective element identifier and a respective second value set relevant to an operation of the second link into the second profile;
generating, by the first MLD, a link reconfiguration frame comprising the first and second profiles; and
transmitting, by the first MLD, the link reconfiguration frame to a second MLD.
